(19) United States
(12) Patent Application Publication
(10) Pub. No.: US 2003/0059199 A1
(43) Pub. Date: Mar. 27, 2003

(54) System and method for creating and viewing digital photo albums

(76) Inventor: Afzal Hossain, San Jose, CA (US)

Correspondence Address: HANCOCK & ESTABROOK, LLP, 1500 MONY Tower I, PO Box 4976, Syracuse, NY, 13221-4976, US

(21) Appl. No.: 09/961,893

(22) Filed: Sep. 24, 2001

(51) Int. Cl. H04N 5/76; H04N 5/781

(52) U.S. Cl. 386/46; 386/125

(57) ABSTRACT

The present invention provides a system and method for creating and viewing a digital photo album on a television with the use of commonly available playback devices, such as a DVD player. The system and method generally comprise a user's creation of digital photographs (e.g., using a digital camera or scanning an analog photo), the user transmitting (electronically or otherwise) the image files to a central computer which then processes and converts the image files into one or combination of any number of predetermined video standards (such as digital VHS standard, VHS standard, DVD-Video standard, DVD standards, Internet Streaming Media standards, compressed digital video standards—MPEG-1, MPEG-2, JPEG, etc . . . ), and then writing the converted data to a transportable storage media that is in accordance with the video standard chosen (i.e., if files converted to a DVD format, then the transportable media must be a DVD).

### BACKGROUND OF THE INVENTION

1. Field of Invention

The present invention relates generally to the field of digital photography, and more particularly to storage of digital photographs in a custom designed format on a medium that permits viewing using commercially available digital video disc players.

2. Description of the Prior Art

Conversion of traditional analog photographs into digital image data has become common. By using a scanner or other digitizing device, a photograph may be stored, digitally manipulated and enhanced, transmitted electronically, displayed, and printed using commonly available computer equipment. The relatively low cost of computers and storage media, such as hard discs, write-able optical discs (e.g., CDs, DVDs), flash memories, and like devices have made digital photography accessible to everyone. Moreover, the advent and advances in digital cameras has made even the digitizing aspect of digital photography less relevant.

In addition to creating single digital images, creation of digital photo albums is also possible with the aid of off the shelf picture publishing software. A drawback of these systems, however, is that the digital images may only be viewed on a computer monitor. Other viewing systems, such as slide projectors, can display the images on a viewing screen or wall provided the data is processed through a computer. Finally, certain digital camera include hardware that permits interconnection of the camera to a television, thereby permitting viewing of the images stored on the media used by the digital camera on a television.

The desirability of viewing photographs on a television, as opposed to a computer monitor, has increased as the image quality on televisions has improved. For example, high definition television and wide screen television has enlarged the image size (viewing area) while improving the image quality through pixel manipulation and larger arrays of pixels per a unit area.

Machines used to display images on a television that are in common use today include the VHS machine and the DVD player. VHS tapes store images in an analog format on a magnetic recording medium. Magnetic recording media suffers from a potential lowering of the record level of data or an instant erasure of data caused by a magnet or the like. Due to these quality problems, VHS is being replaced in the market by higher image quality DVD players.

3. Objects and Advantages of the Present Invention

It is therefore a principal object and advantage of the present invention to provide a system and method for creating digital photo albums that may be viewed on a television through commonly available playback machines.

It is another object and advantage of the present invention to provide a system that permits users to view photos on a television in any one of a number of user defined sequences.

It is a further object and advantage of the present invention to provide a system and method for creating digital photo albums easily and inexpensively.

It is still another object and advantage of the present invention to provide a system and method for creating digital photo albums that are durable and able to withstand repeated uses over a long period of time.

Other objects and advantage of the present invention will in part be obvious, and in part appear hereinafter.

### SUMMARY OF THE INVENTION

In accordance with the foregoing objects and advantages, the present invention provides a system and method for creating and viewing a digital photo album on a television with the use of commonly available playback devices, such as a DVD player. The system and method generally comprise a user's creation of digital photographs (e.g., using a digital camera or scanning an analog photo), the user electronically, or otherwise (e.g., regular courier or mail service), transmitting the image files to a central computer which then processes and converts the image files into one or combination of any number of predetermined video standards (such as digital VHS standard, VHS standard, DVD-Video standard, DVD standards, Internet Streaming Media standards, compressed digital video standards—MPEG-1, MPEG-2, JPEG, etc . . . ), and then writing the converted data to a transportable storage media that is in accordance with the video standard chosen (i.e., if files converted to a DVD format, then the transportable media must be a DVD).

Prior to writing the data to a transportable media, it is possible for the user to select predefined viewing sequences for the images. A menu file permits the user to group the image files into any number of desired playback sequences. Once the user selects the playback sequence or sequences, the central computer will then group the images according to the selection, and format the images into the selected video standard, and then write the formatted date a suitable transportable media. The transportable media is then sent to the user for viewing at his or her pleasure. A programable remote control can be used by the user for playing back the image groups in the desired sequence.

### BRIEF DESCRIPTION OF THE DRAWINGS

The present invention will be more fully understood and appreciated by reading the following Detailed Description in conjunction with the accompanying drawing figures, wherein:

FIG. 1 is a high level block diagram illustrating a preferred mode of practicing the present invention;

FIG. 2 is a medium level block diagram illustrating the present invention;

FIG. 3 is a high level flow chart illustrating the operation of the present invention;

FIG. 4 is a block diagram illustrating digital photos grouped into predetermined playback sequences;

FIG. 5 is a flowchart illustrating possible playback sequences of the image groups;

FIG. 6 is a flowchart illustrating possible playback sequences of the image groups;

FIGS. 7a-7b are representative views of a typical menu screen display that would appear on the video display device, such as a television, for selecting the presentation playback of the digital photos;

FIG. 7c is a representative view of a remote control panel that may be used to transmit commands to the video reproducing device;

FIG. 8 is a high level block diagram of a second alternate embodiment of the present invention;

FIG. 9 is a high level block diagram of a third alternate embodiment of the present invention;

FIG. 9a is a perspective view of a consumer electronic recording device used in the third alternate embodiment;

FIG. 10 is a high level block diagram of a fourth alternate embodiment of the present invention;

FIG. 11 is a high level block diagram of a fifth alternate embodiment of the present invention; and

FIG. 12 is a high level block diagram of a sixth alternate embodiment of the present invention.

### DETAILED DESCRIPTION

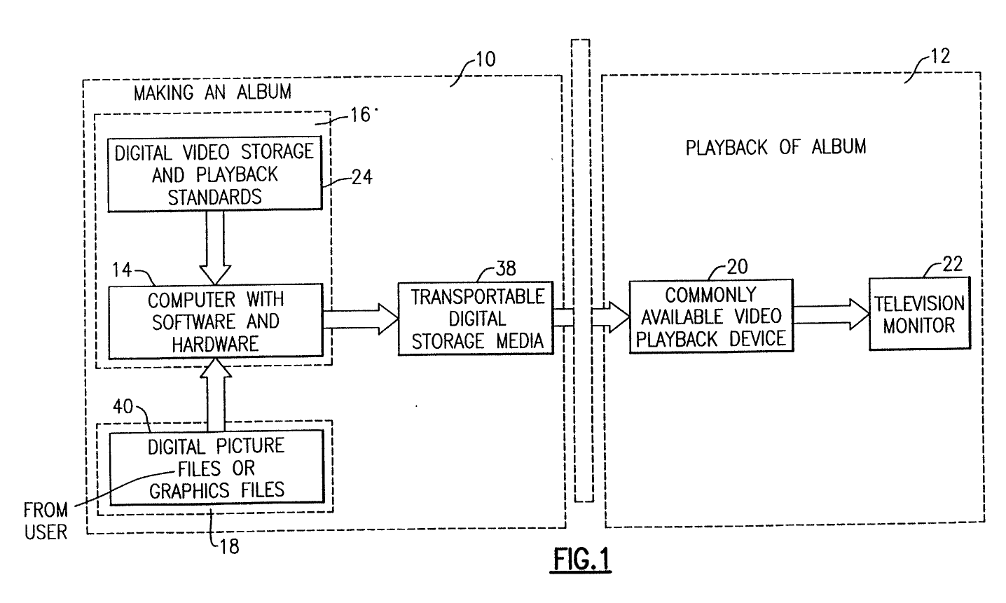

Referring now to the drawings, wherein like reference numeral refer to like parts throughout, there is seen in FIG. 1 a block diagram illustrating a system for creating a digital photo album that may be viewed on a television using conventional video playback equipment. The system generally comprises a photo album generating environment, designated generally by reference numeral 10, and a photo album playback environment, designated generally by reference numeral 12. Within photo album generating environment 10 is a computer 14 (“computer” being defined broadly to include any device capable of receiving and processing data) located at a remote location 16, and a user location 18 from which the photo files originate. Within the photo album playback environment 12 is a video playback device 20 and a television 22, both of which are located separate from remote location 16.

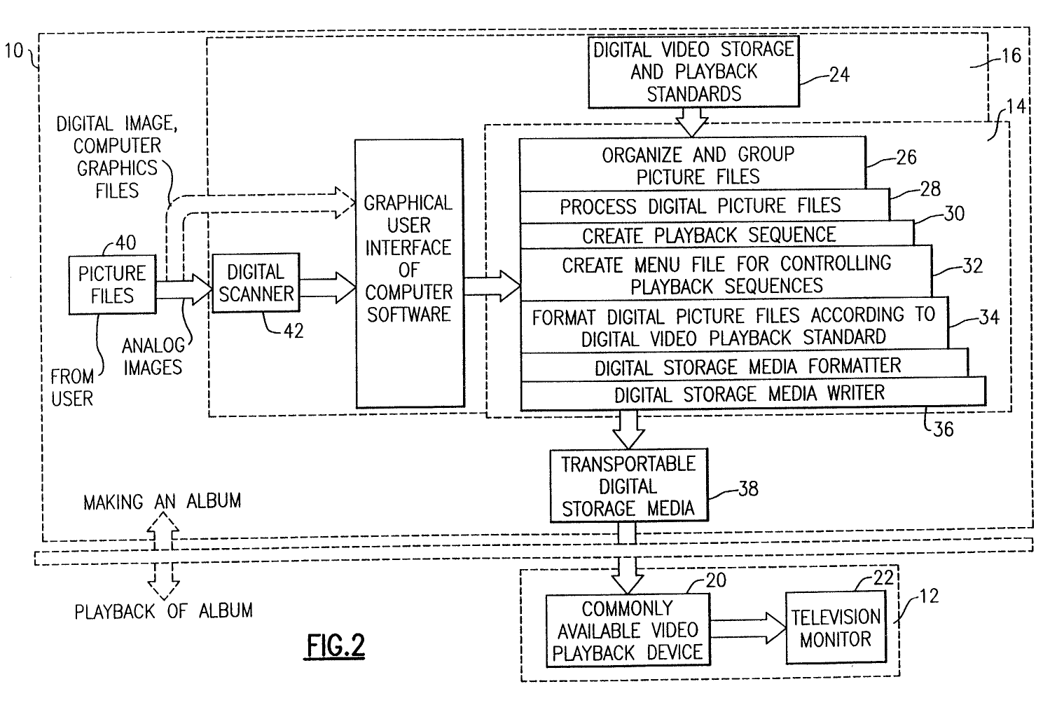

Computer 14 includes a memory for storing digital picture files and software that includes subroutines containing various video standards 24 (e.g., VHS, Digital VHS, DVD-Video, DVD-Multi, DVD, Internet Streaming Media, and compressed digital video standards such as MPEG-1, MPEG-2, and JPEG). The standards for DVD (read only disc) may be found in the following documents available by license from DVD Logo & Licensing Corporation (managed by Toshiba Corporation of Tokyo, Japan: DVD-ROM (Part 1: Physical Specification, Part 2 File System Specifications), DVD-Video (Part 3: Video Specifications), DVD-Audio (Part 4: Audio Specifications); and the following contains the MPEG (Moving Picture Expert Group) standards: MPEG-1 (System): Standard ISO/IEC 11172-1, MPEG-1 (Video): Standard ISO/IEC 11172-2, MPEG-1 (Audio): Standard ISO/IEC 11172-3, MPEG-2 (System): Standard ISO/IEC 13818-1, MPEG-2 (Video): Standard ISO/IEC 13818-1, MPEG-2 (Audio): Standard ISO/IEC 13818-3; AC-3 standards: “Digital Audio Compression Standard,” Advanced Television System Committee, Washington. A user preselects which video standard 24 he or she desires for the digital photo album. With reference to FIG. 2, the software and hardware residing in computer 14 is capable of receiving digital video files from a user, grouping 26 the picture files according to the user's choices, processing/formatting 28 the picture files into the selected video standard 24, creating a playback sequence 30 for the pictures according to the user's selections, creating a menu 32 that the user may use to control the playback sequence of the photos, processing/formatting 34 the picture files and menu for storage in compliance with the selected video storage standard 24, and writing 36 the formatted digital files to a transportable storage media 38 that is the same as the chosen video standard 24 (e.g., if DVD standard chosen, files stored on a DVD).

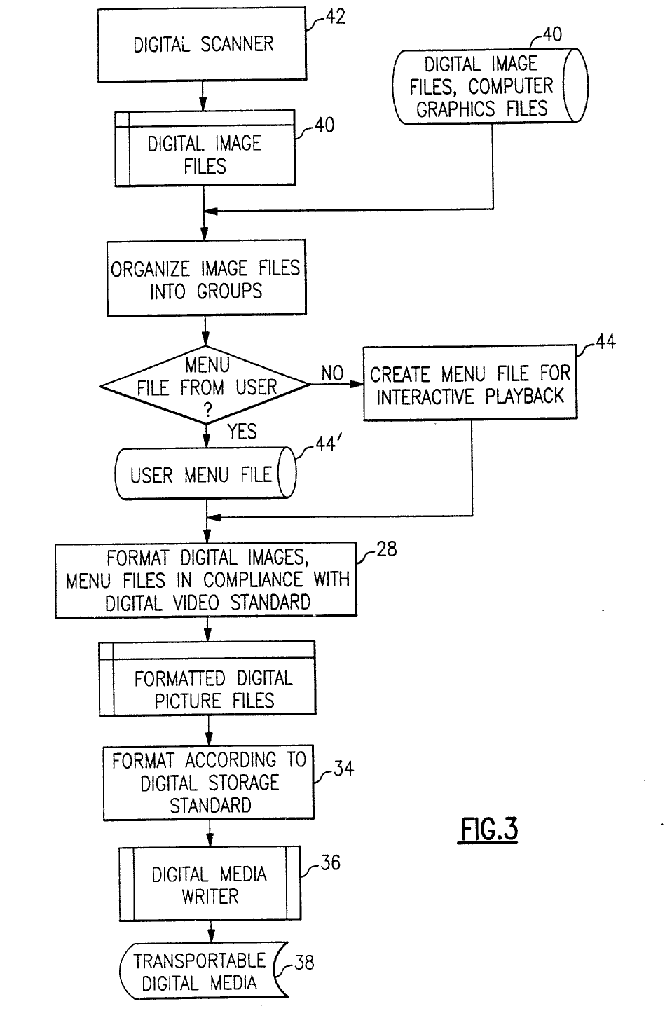

With reference to FIG. 3, in operation, a user would save a group of picture files 40 in a digital format. This is done either through taking the pictures with some form of digital camera, or by digitizing analog photographs with a digital scanner 42. The user would then interface with the computer 14 residing at remote location 16 via the Internet, or some other form of networked connection. The user would then send the picture files 40 to computer 14, and organize picture files 40 into desired groups (this is preferably done through the use of a browser program that serves as the graphical user interface and permits the user to “drag and click” the image files into a predefined groups and sequences within the groups). Computer 14 will then create a menu file 44 which will be used for interactive playback of the images (or if the user already has a menu file, computer 14 may use this pre-existing menu file 44′). The software and hardware of computer 14 then completes the process of creating the digital photo album as previously described; that is processing/formatting 28 the picture files into the selected video standard 24, creating the playback sequence 30 for the pictures according to the user's predesignated selections of groups and sequences, creating a menu 32 that the user may use to control the playback sequence of the photos, processing/formatting 34 the picture files and menu for storage in compliance with the selected video storage standard 24, and writing 36 the formatted digital files to a transportable storage media 38 that is the same as the chosen video standard 24 (e.g., if DVD standard chosen, files stored on a DVD). The device/driver (which may be external or internal) for writing the files is commercially available, such as from Philips Corporation (Writer No. S-201).

As an alternative to the user electronically transmitting digital image files to computer 14, the user could also send actual photographs (or a disc with photos saved thereon) to photo album generating environment 10 where the photos could be digitized and processed as detailed herein.

In the playback environment 12, the user would receive the media 38 with the digital photo album stored thereon, and insert that media into the video playback device 46 which can read and display files saved in the particular video format 24 (i.e., if DVD standard chosen, the playback device would be a DVD player). As will be described in greater detail hereinafter, the user may then navigate through and view the photo album on a television 22 with the aid of a remote control 48.

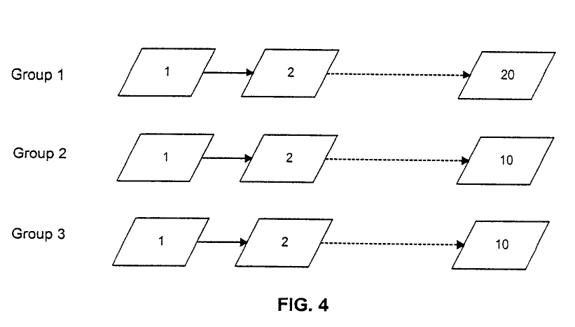

With reference to FIG. 4, sequences of digital files are selected and placed in groups 1, 2, and 3. Group 1 is illustrated as containing a total of 20 images (each rectangle representing a single picture), while Groups 2 and 3 each contain 10 images. The images can be grouped in any desired manner.

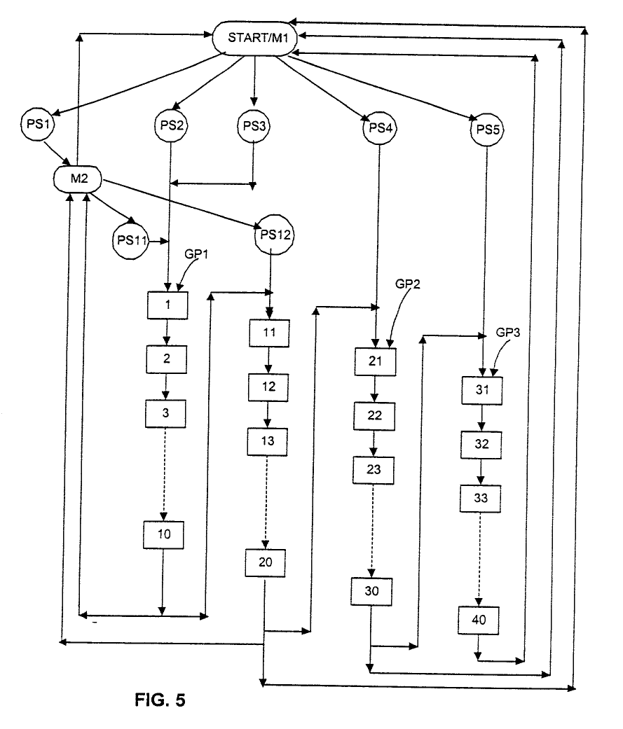

With reference to FIG. 5, a desired reproduction sequence of the digital picture files of Groups 1, 2, and 3 is illustrated. Start/M1 is the root menu file 32 that contains the selection points PS1, PS2, PS3, PS4, and PS5. The pictures in Group 1 are further divided into two playback sequences. Menu image M2 represents selection points PS11 and PS12 of playback sequences of digital pictures in Group 1. Each playback sequence comprises a linear sequence of digital picture files and return path to selection points.

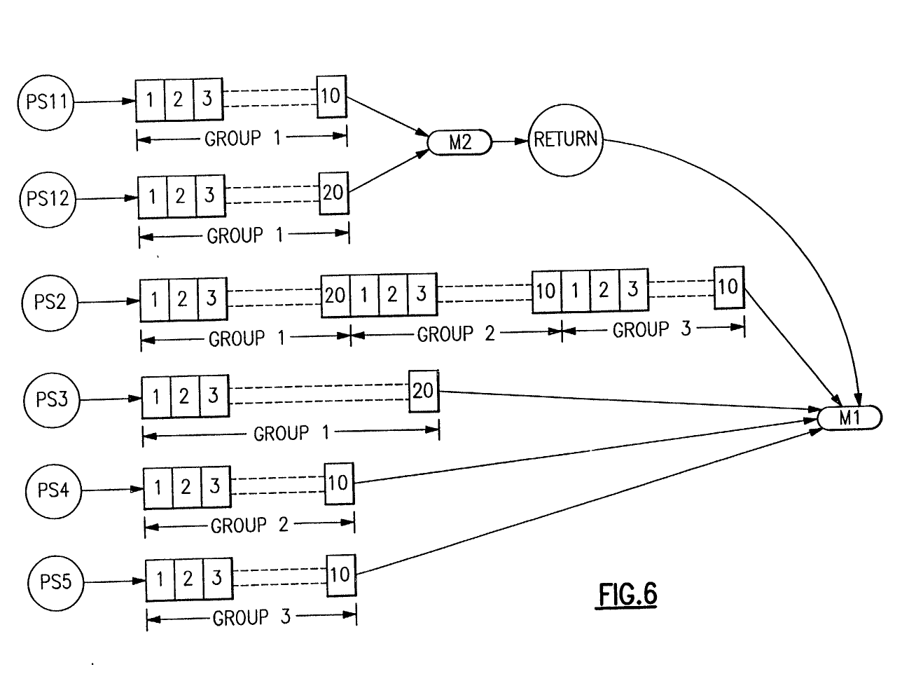

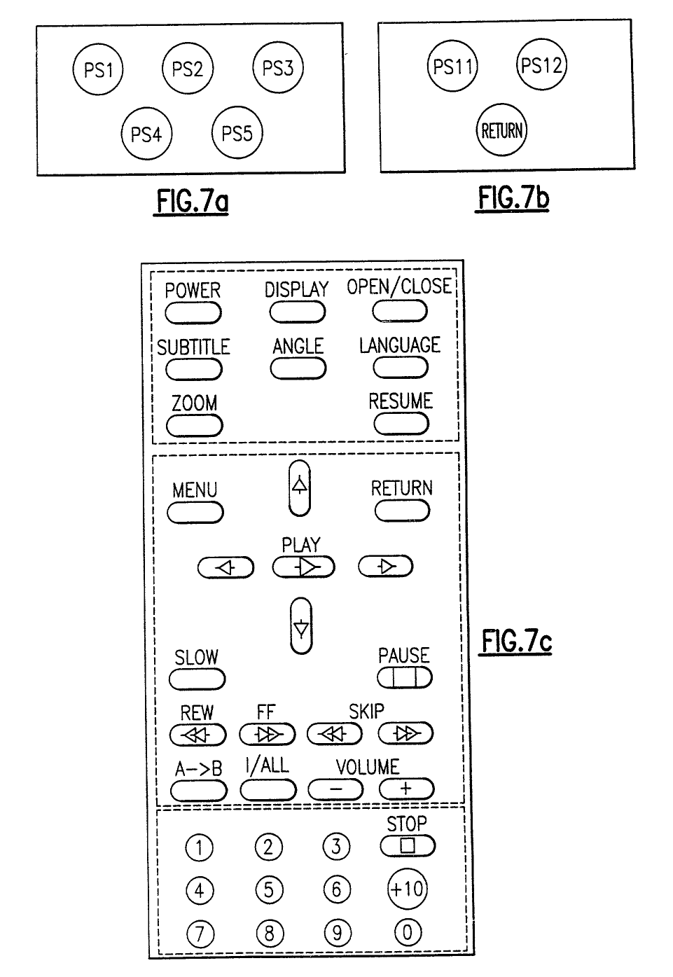

With reference to FIG. 6, all the playback sequences of the digital picture files shown in FIG. 5 are illustrated. FIGS. 7a and 7b illustrate example menu images that would appear on television 22 and which contains the selection points of the playback sequences. A remote control unit 48, shown in FIG. 7c, is used to transmit commands to select selection points on the menu image. These menu images are stored on media 38 along with the digital picture files. Computer 14 creates the playback sequence in accordance with the video standard 24 from the grouping of the digital pictures.

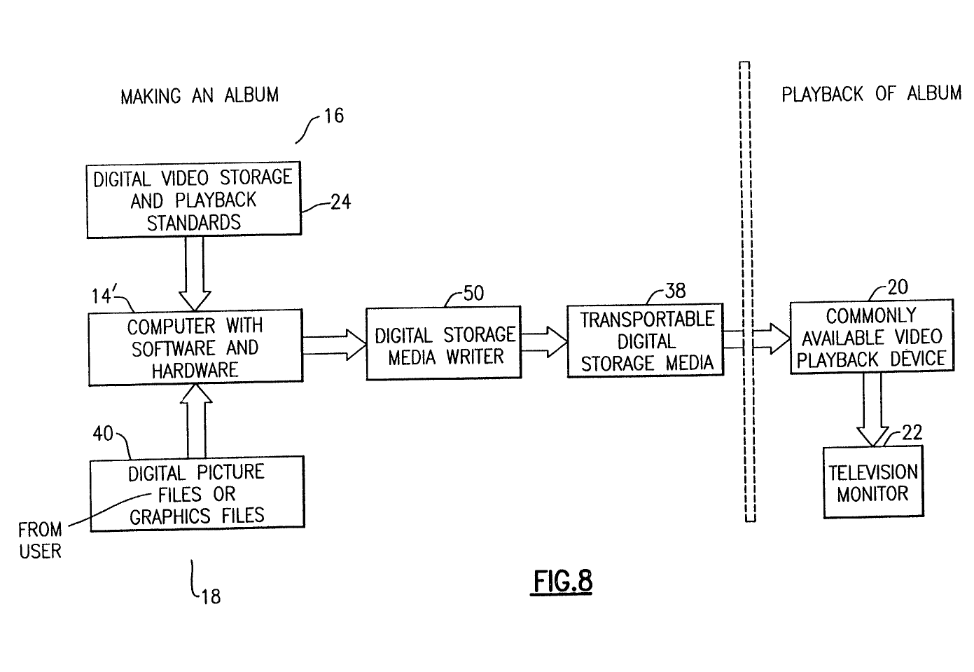

With reference to FIG. 8, an alternate embodiment of the present invention is illustrated. The system is identical to the preferred embodiment described above, except that in this embodiment computer 14 does not include internal hardware for writing the formatted picture files to media 38. Instead, an external media writer 50 is interconnected between media 38 and computer 14.

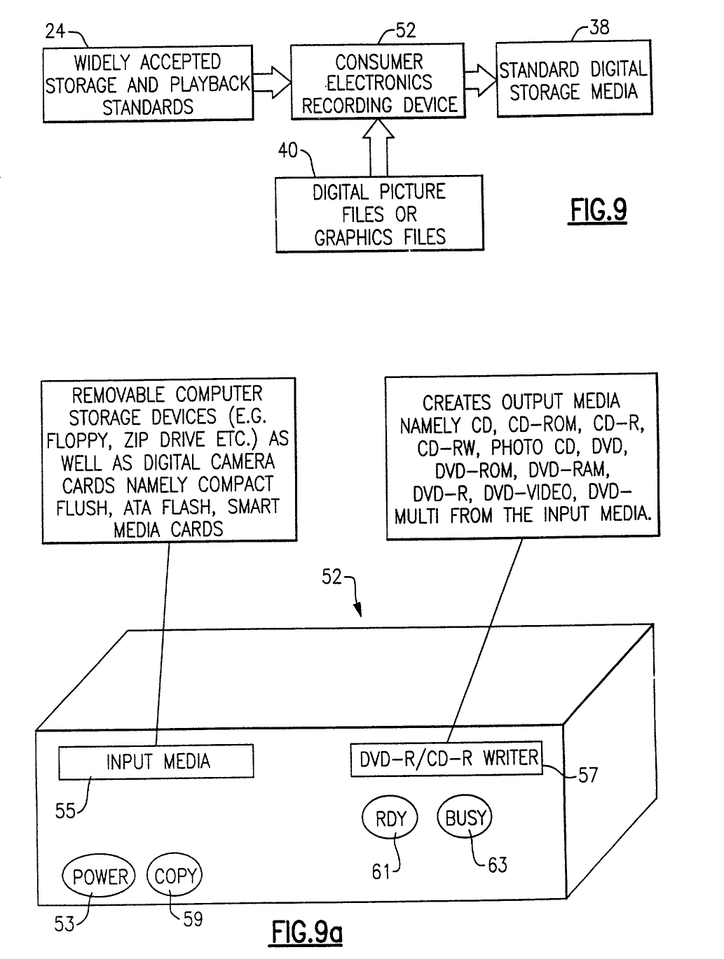

With reference to FIG. 9, a consumer electronics recording device 52 is modified to include the software and hardware present in computer 14 to create the formatted digital picture files, and then write those files to media 38. This would eliminate the need for the user to send the picture files to computer 14 for processing, instead having the ability to create the media from his or her own recording device.

With reference to FIG. 9a, consumer electronic recording device 52 generally comprises a power button 53 to ativate the power source (traditional AC power, a memory storage device (such as a Flash RAM) 55, a slot/drive 57 for receiving recording media (such as a DVD or CD), a “copy” button 59 which activates the copying of the image files from memory device 55 to the new recording media (e.g., DVD or CD), and indicator buttons RDY (ready) 61 and BUSY (busy) 63 to indicate the status of the processing.

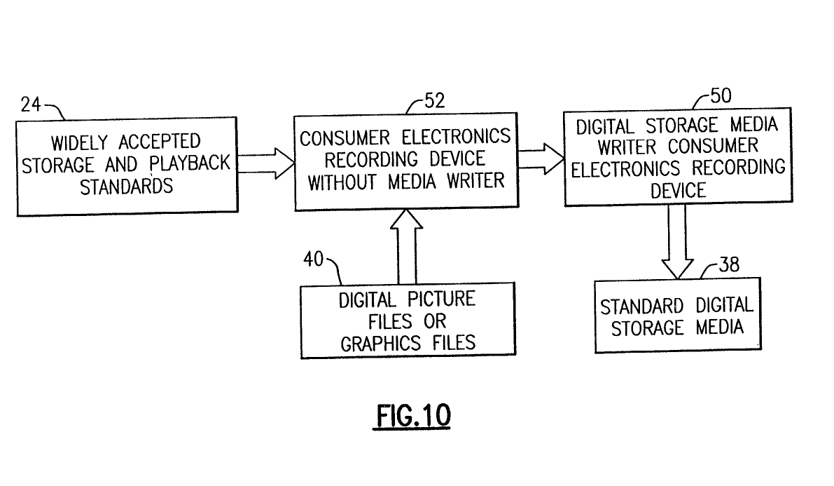

With reference to FIG. 10, the same system as that shown in FIG. 9 is reproduced with the exception that the recording device 52 does not include a media writer incorporated therein. Instead, an external media writer 50 (same as shown in FIG. 8) is interconnected between media 38 and recording device 52.

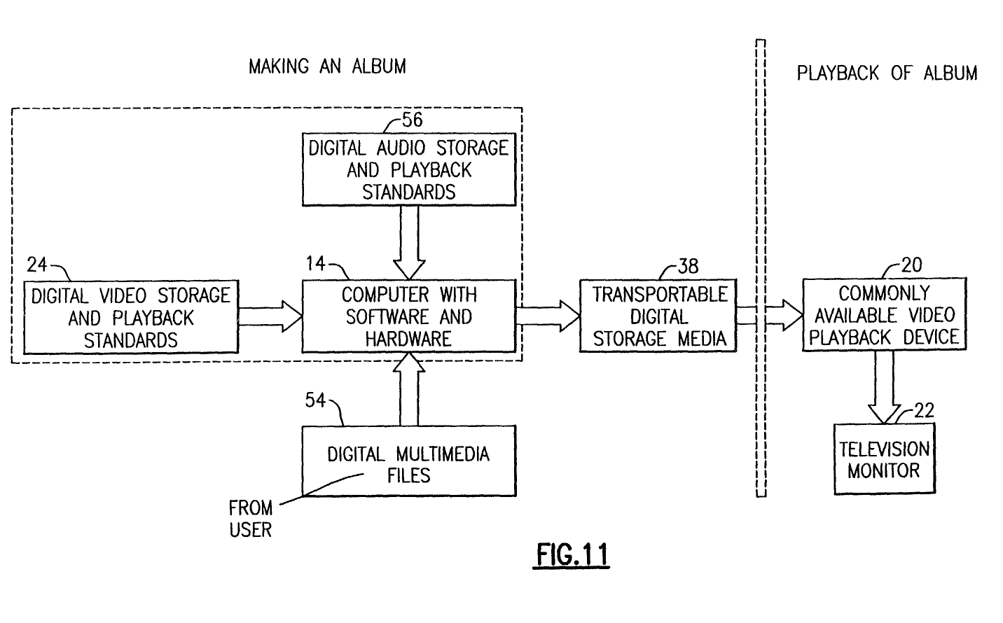

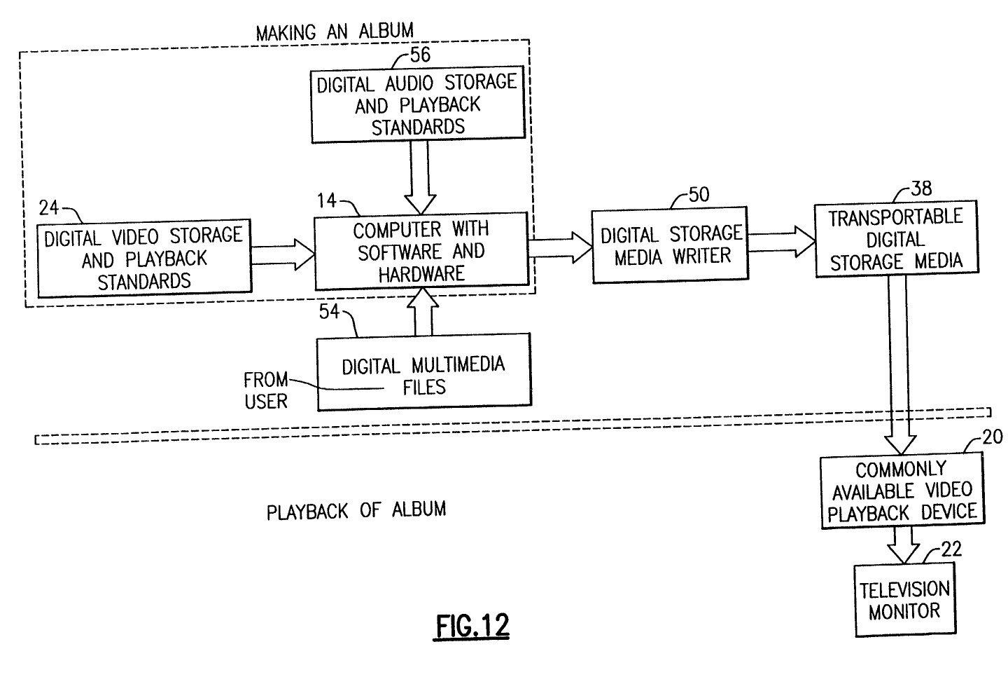

Before proceeding with a description of the embodiments illustrated in FIGS. 11 and 12, it is necessary to explain that computer 14 is also capable of processing digital audio and/or multimedia files 54 according to digital audio storage and playback standards 56. Audio standards 56 include, for example, DVD-Audio, DVD-Multi, DVD, Internet Streaming Media standards, and compressed digital audio standards, such as AC-3, MPEG-1, MPEG-2 audio, etc . . . . Uncompressed digital audio files are also supported.

Referring to FIG. 11, computer 14 receives multimedia files 54 from the user. In the same manner as computer 14 processes digital picture files 40, it will process multimedia files 54 and write the formatted files to media 38. Computer 14 can process one or any combination of digital multimedia files according to corresponding standards to create media 38.

Referring to FIG. 12, an analog to the embodiment shown in FIG. 8 is shown. Specifically, computer 14 does not include an internal media writer, but instead needs to interconnect to an external media writer 50.

The present invention should not be limited to the specific examples described herein, but should extend to its full spirit and scope as defined by the appended claims.

What is claimed is:

1. A computer system for creating a digital photo album, comprising:
a. means for receiving at least one digital file of a first format;
b. memory for storing said at least one digital file;
c. means for converting said at least one digital file from said first format to a second format that is a video standard;
d. means for writing said at least one digital file to a transportable storage media.

2. The computer system of claim 1, further comprising means for grouping said digital files into at least one group.

3. The computer system of claim 2, further comprising means for organizing said at least one digital file within each of said at least one group into a predefined order.

4. The computer system of claim 3, further comprising means for creating a menu file in which each of said at least one group of said at least one digital file may be accessed.

5. The computer system of claim 1, wherein said first format is one that supports graphical images.

6. The computer system of claim 1, wherein said second format is at least one of VHS, Digital VHS, DVD-Video, DVD-Multi, DVD, Internet Streaming Media, and compressed digital video standards, including MPEG-1, MPEG-2, and JPEG.

7. The computer system of claim 1, wherein said first format is a multimedia file format.

8. The computer system of claim 7, further comprising means for converting said multimedia files to a third format that is a digital audio standard.

9. The computer system of claim 8, wherein said third format is at least one of DVD-Audio, DVD-Multi, DVD, Internet Streaming Media standards, and compressed digital audio standards, including AC-3, MPEG-1 audio, and MPEG-2 audio.

10. A method for creating a digital photo album that is viewable on a television, comprising the steps of:
a. sending at least one image file saved in a first file format from a first location to a second location;
b. receiving said at least one image file at said second location which has a first computer located there;
c. converting said at least one image file from said first file format to a second file format that is a digital video standard, thereby creating at least one digital image file;
d. saving said at least one digital image file in said second file format; and
e. writing said at least one digital image file to a transportable media.

11. The method according to claim 10, further comprising the step of organizing said at least one digital image file into at least one group.

12. The method according to claim 11, further comprising the step of organizing the sequence of said at least one digital image file into a predefined order.

13. A method for creating a digital photo album that is viewable on a television, comprising the steps of:
a. storing at least one digital image file in a first file format;
b. converting said at least one digital image file from said first file format to a second file format that is a video standard;
c. saving said at least one digital image file in said second file format; and
d. writing said at least one digital image file to a transportable media.

14. The method according to claim 13, further comprising the step of organizing said at least one digital image file into at least one group.

15. The method according to claim 14, further comprising the step of organizing the sequence of said at least one digital image file into a predefined order.
